(19) United States
(12) Patent Application Publication
(10) Pub. No.: US 2026/0233878 A1
(43) Pub. Date: Aug. 13, 2026

(54) STRAPPING MACHINE WITH A DEVICE-IDENTIFYING MODULE

(71) Applicant: Signode Industrial Group LLC, Tampa, FL (US)

(72) Inventors: Joel Patel, Hawthorn Woods, IL (US); Jürgen Höhn, Bad Berneck (DE)

(21) Appl. No.: 19/154,285

(22) PCT Filed: Feb. 7, 2024
(86) PCT No.: PCT/US2024/014762

§ 371 Date: Aug. 6, 2025

Related U.S. Application Data
(60) Provisional application No. 63/485,319, filed on Feb. 16, 2023.

(51) Int. Cl. B65B 59/04; G05B 15/02

(52) U.S. Cl. CPC B65B 59/04; G05B 15/02

(57) ABSTRACT

Various embodiments of the present disclosure provide a strapping machine including a strapping head configured to form a tensioned loop of strap around a load. The strapping head includes multiple removable and replaceable devices, such as a strap-feeding assembly, a strap-tensioning assembly, and a strap-sealing assembly, each of which is associated with a different device identifier. The strapping head includes a device-identifying module that is associated with a first one of the devices and that includes a device-identifying-module controller storing data representing the device identifier of the first device. The device-identifying-module controller is configured to, once powered on, automatically transmit a signal representing the device identifier to a strapping-machine controller of the strapping machine. The strapping-machine controller is configured to generate and store data representing the device identifier based on the received signal.

### PRIORITY

This application claims priority to and the benefit of U.S. Provisional Patent Application No. 63/485,319, filed Feb. 16, 2023, the entire contents of which is incorporated herein by reference.

### FIELD

The present disclosure relates to strapping machines for forming tensioned loops of strap around a load, and particularly to strapping machines with a device-identifying module for identifying a device of the strapping machine, such as a strap-feeding assembly, a strap-tensioning assembly, or a strap-feeding assembly.

### BACKGROUND

A strapping device forms a loop of plastic strap (such as polyester or polypropylene strap), metal strap (such as steel strap), or paper strap around a load. Certain strapping devices include a support surface that supports the load, a strap chute that circumscribes the support surface, a strap reservoir (also called a strap accumulator or a slack box) storing strap in a slack state, a strapping head that forms the strap loop using strap drawn from the strap reservoir, a controller that controls the strapping head to strap the load, and a frame that supports these components. The strap reservoir is periodically replenished via strap drawn from a strap coil. A typical strapping head includes a strap-feeding assembly for feeding strap from the strap reservoir into and around the strap chute and for retracting the strap so it exits the strap chute and moves radially inwardly into contact with the load with the excess being fed back into the strap reservoir, a strap-tensioning assembly for tensioning the strap around the load, and a strap-sealing assembly for attaching two portions of the strap together to form the strap loop and for cutting the strap from the strap supply. The strapping machine includes several guides that define strap channels that the strap passes through as it moves through the various components of the strapping machine. The strap channels and the strap chute together define a strap path that the strap moves through.

To strap the load, the strapping machine carries out a strapping process including a strap-feeding process, a strap-retraction process, a strap-tensioning process, and a strap-sealing process. The strapping machine first carries out the strap-feeding process during which the strap-feeding assembly feeds strap (with the leading strap end first) from the strap reservoir through the strap-tensioning assembly, through the strap-feeding assembly, through the strap-sealing assembly, and into and around the strap chute until the leading strap end returns to the strap-sealing assembly. The strapping machine then carries out the strap-retraction process during which the strap-sealing assembly holds the leading strap end while the strap-feeding assembly retracts the strap to pull the strap out of the strap chute and onto and around the load and to push the excess strap back into the strap reservoir. The strapping machine then carries out the strap-tensioning process during which the strap-tensioning assembly tensions the strap to a designated strap tension. The strapping machine then carries out the strap-sealing process during which the strap-sealing assembly attaches the leading strap end to another portion of the strap to form a strap joint and cuts the strap from the strap supply, thereby forming a strap loop around the load and completing the strapping process.

In certain strapping machines, the strap-feeding, strap-tensioning, and strap-sealing assemblies are separate from one another and independently removable from the frame so they can be replaced. This is beneficial for operators because it reduces downtime-a spare assembly can be quickly and easily swapped in for an existing assembly when the existing assembly breaks or otherwise needs to undergo service.

Certain strapping machines collect and store data related to the strapping process and the strap-feeding, strap-tensioning, and strap-sealing assemblies of the strapping machine. For instance, certain strapping machines store data representing a count of the number of strapping processes carried out by each of the strap-feeding, strap-tensioning, and strap-sealing assemblies. Some strapping machines store data representing feedback from sensors installed in the various assemblies, such as from sensors integrated into the motors used to drive certain components of the various assemblies. The strapping machines transmit this data via a network to an external computing device, such as a cloud-based server, which aggregates the data over time and can analyze this data to monitor machine performance. One problem with this existing setup is that the data is not tied to individual strap-feeding, strap-tensioning, and strap-sealing assemblies, which makes it difficult-if not impossible-to analyze the data to determine the performance of an individual assembly.

### SUMMARY

Various embodiments of the present disclosure provide a strapping machine including a strapping head configured to form a tensioned loop of strap around a load. The strapping head includes multiple removable and replaceable devices, such as a strap-feeding assembly, a strap-tensioning assembly, and a strap-sealing assembly, each of which is associated with a different device identifier, such as a serial number. The strapping head includes a device-identifying module that is associated with a first one of the devices and that includes a device-identifying-module controller storing data representing the device identifier of the first device. The device-identifying-module controller is configured to, once powered on, automatically transmit a signal representing the device identifier to a strapping-machine controller of the strapping machine. The strapping-machine controller is configured to generate and store data representing the device identifier based on the received signal.

### BRIEF DESCRIPTION OF THE FIGURES

FIG. 1 is a diagrammatic view of one example embodiment of a strapping machine of the present disclosure.

FIG. 2 is a block diagram of certain components of the strapping machine of FIG. 1.

FIG. 3 is a block diagram of the first device-identifying module of the strapping machine of FIG. 1.

FIG. 4 shows a representation of the first device-identifier signal and the first transmission signal transmitted by the first device-identifying module of FIG. 3 for an example first device identifier.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

Various embodiments of the present disclosure provide a strapping machine including a strapping head configured to form a tensioned loop of strap around a load. The strapping head includes multiple removable and replaceable devices, such as a strap-feeding assembly, a strap-tensioning assembly, and a strap-sealing assembly, each of which is associated with a different device identifier (such as a serial number). The strapping head includes a device-identifying module that is associated with a first one of the devices and that includes a device-identifying-module controller storing data representing the device identifier of the first device. The device-identifying-module controller is configured to, once powered on, automatically transmit a signal representing the device identifier to a strapping-machine controller of the strapping machine. The strapping-machine controller is configured to generate and store data representing the device identifier based on the received signal. This enables the strapping-machine controller to associate data related to the performance of the first device using the device identifier of the first device to differentiate the first device from the other devices of the strapping machine and from replacement devices.

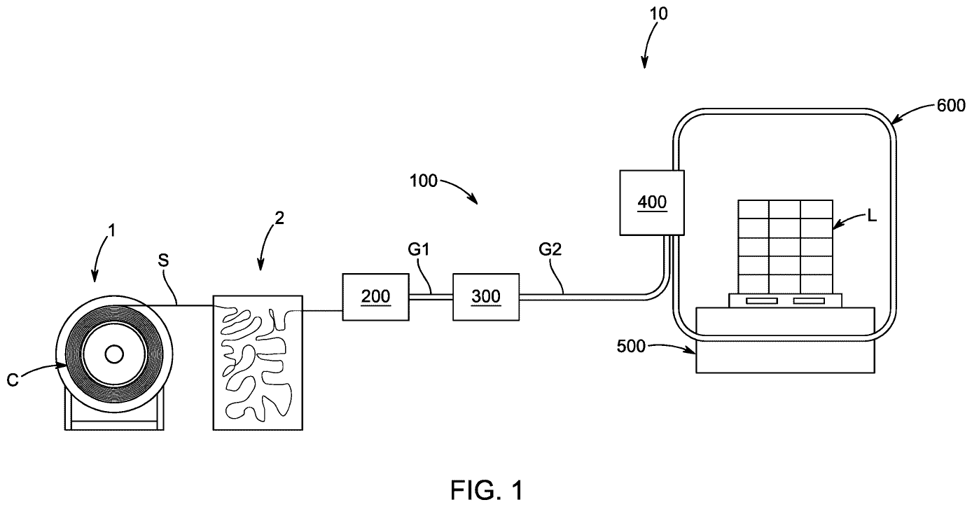

FIGS. 1-3 show one example strapping machine 10 of the present disclosure and components thereof. The strapping machine 10 is configured to draw strap S from a strap supply 2, which is configured to store strap for use by the strapping machine 10 and which is supplied with strap S by from a strap coil C on a coil support 1. The strapping machine 10 is any suitable strapping machine configured to draw the strap S from the strap supply 2 and form a tensioned loop of the strap S around a load. The strapping device 10 may be configured for use with plastic strap (such as polyester or polypropylene strap), metal strap (such as steel strap), and/or paper strap. In this example embodiment, the strapping device 10 includes a strapping-machine frame (not shown); a strapping head 100 including a strap-feeding assembly 200, a strap-tensioning assembly 300, and a strap-sealing assembly 400; a load supporter 500; a strap chute 600; strap guides G1 and G2; and a strapping-machine controller 1000.

The strapping-machine frame is configured to support some (or all) of the other components of the strapping machine 10 and may be formed of any suitable components arranged in any suitable configuration. The load supporter 500 is configured to support loads—such as the palletized load L—as they are strapped by and as they move through the strapping machine 10. The load supporter 500 includes a support surface (not labeled) on which loads are positioned during strapping and over which loads move as they move through the strapping machine 10. In this example embodiment, the support surface includes multiple rollers that facilitate movement of the loads through the strapping machine 10. The rollers may be driven or undriven. In other embodiments, the support surface includes a driven conveyor instead of rollers.

The strap chute 600 circumscribes the support surface of the load supporter 500 and defines a strap path that the strap follows when fed through the strap chute 600 and from which the strap is removed when retracted. The strap chute 600 includes two spaced-apart first and second upstanding legs (not labeled), an upper connecting portion (not labeled) that spans the first and second legs, a lower connecting portion (not labeled) that spans the first and second legs and is positioned in the load supporter 500, and elbows (not labeled) that connect these portions. The radially inward wall of the strap chute 600 is formed from one or more gates that are spring biased to a closed position that enables the strap to traverse the strap path when fed through the strap chute 600. When the strap-feeding assembly 200 exerts a pulling force on the strap to retract the strap, the pulling force overcomes the biasing force of the springs and causes the gates to pivot to an open position, thereby releasing the strap from the strap chute 600 so the strap moves radially inward into contact with the load L.

The strap-feeding assembly 200, the strap-tensioning assembly 300, and the strap-sealing assembly 400 are configured to operate together to form a tensioned strap loop around the load by feeding the strap through the strap chute 600, holding the leading strap end while retracting the strap to remove it from the strap chute 600 so it contacts the load L, tensioning the strap around the load L to a designated tension, connecting the leading strap end to another portion of the strap, and cutting the strap from the strap supply. In this example embodiment, the strap-feeding assembly 200, the strap-tensioning assembly 300, and the strap-sealing assembly 400 are separate modules that are individually attachable to and removable from the strapping-machine frame. The guide G1 extends between the strap-feeding and strap-tensioning assemblies 200 and 300 and is configured to guide the strap as it moves between those assemblies. The guide G2 extends between the strap-tensioning and strap-sealing assembly 300 and 400 and is configured to guide the strap as it moves between those assemblies. In other embodiments these assemblies form a strapping head that is not comprised of self-contained and individually removable modules and it itself a removable assembly.

The strap-feeding assembly 200 is configured to feed strap from the strap supply 2 through the strap-tensioning assembly 300 and the strap-feeding assembly 400 and into and around the strap chute 600 and to retract the strap so it exits the strap chute 600 and contacts the load L. The strap-feeding assembly 200 includes a driven feed roller and an opposing pinch roller and a feed motor configured to drive the feed roller to carry out this functionality. The strap-feeding assembly 200 includes one or more sensors 280 each configured to sense a physical phenomenon related to operation of the strap-feeding assembly 200 and to convert it into a representative output signal. For instance, in certain embodiments, one of the sensors 280 detects each feed and retract cycle carried out by the strap-feeding assembly 200 by detecting movement of the strap, the rollers, and/or the feed motor. The strap-feeding assembly 200 also includes a first device-identifying module 290 for identifying the strap-feeding assembly 200, as described below. The strap-feeding assembly 200 and the components thereof (e.g., the feed motor, the sensors 280, and the first device-identifying module 290) are configured to communicate with the strapping-machine controller 1000 (described below) via a suitable wired or wireless communications interface.

The strap-tensioning assembly 300 is configured to tension the strap around the load L. The strap-tensioning assembly 300 includes a driven tensioning wheel and an opposing pinch roller and a tensioning motor configured to drive the tensioning wheel. Once the strap-feeding assembly 200 retracts the strap so it contacts the load L, the tensioning motor drives the tensioning wheel to tension the strap to a designated (typically preset) tension. The strap-tensioning assembly 300 includes one or more sensors 380 each configured to sense a physical phenomenon related to operation of the strap-tensioning assembly 300 and to convert it into a representative output signal. For instance, in certain embodiments, one of the sensors 380 detects each tensioning cycle carried out by the strap-tensioning assembly 300 by detecting movement of the strap, the tension wheel, the pinch roller, and/or the tensioning motor. The strap-tensioning assembly 300 also includes a second device-identifying module 390 for identifying the strap-tensioning assembly 300, as described below. The strap-tensioning assembly 300 and the components thereof (e.g., the tensioning motor, the sensors 380, and the second device-identifying module 390) are configured to communicate with the strapping-machine controller 1000 (described below) via a suitable wired or wireless communications interface.

The strap-sealing assembly 400 is configured to, after the strap-tensioning assembly 300 tensions the strap to the designated tension, attach the leading strap end to another portion of the strap to form the strap loop and to cut the strap from the strap supply. The manner of attaching the portions of the strap to one another depends on the type of strapping machine and the type of strap. Certain strapping machines configured for plastic or paper strap include a strap-sealing assembly with a friction welder, a heated blade, or an ultrasonic welder configured to attach the leading and trailing strap ends to one another. Some strapping machines configured for metal strap include a strap-sealing assembly with jaws that mechanically deform (referred to as “crimping” in the industry) or cut notches into (referred to as “notching” in the industry) a seal element positioned around the leading and trailing strap ends to attach them to one another. Other strapping machines configured for metal strap include a strap-sealing assembly with punches and dies configured to form a set of mechanically interlocking cuts in the leading and trailing strap ends to attach them to one another (referred to in the strapping industry as a “sealless” attachment). Still other strapping machines configured for metal strap include a strap-sealing assembly with spot, inert-gas, or other welders configured to weld the leading and trailing strap ends to one another.

The strap-sealing assembly 400 includes one or more sensors 480 each configured to sense a physical phenomenon related to operation of the strap-sealing assembly 400 and to convert it into a representative output signal. For instance, in certain embodiments, of the sensors 480 detects each sealing cycle carried out by the strap-sealing assembly 400 by detecting movement of one or more of the components of the strap-sealing assembly 400. The strap-sealing assembly 400 also includes a third device-identifying module 490 for identifying the strap-sealing assembly 400, as described below. The strap-sealing assembly 400 and the components thereof (e.g., the sensors 480 and the third device-identifying module 490) are configured to communicate with the strapping-machine controller 1000 (described below) via a suitable wired or wireless communications interface.

The strapping-machine controller 1000 includes a processing device (or devices) communicatively connected to a memory device (or devices). For instance, the controller may be a programmable logic controller. The processing device may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device may include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the strapping machine 10. In certain embodiments, the strapping machine 10 includes a single controller, while in other embodiments the strapping machine 10 has multiple controllers that operate together.

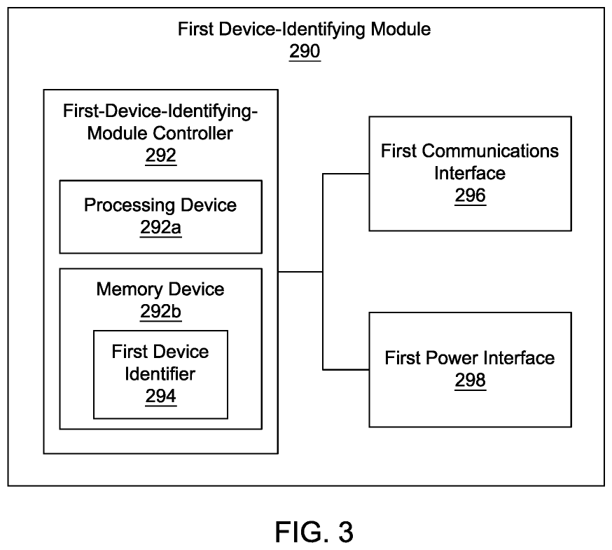

FIG. 3 shows the first device-identifying module 290. The first device-identifying module 290 includes a first device-identifying-module controller 292, a wired or wireless first communications interface 296, and a first power interface 298. The first communications interface 296 is configured to enable the first-device-identifying-module controller 292 to communicate with the strapping-machine controller 1000 via the communications interface of the strap-feeding assembly 200. The first power interface 298 enables the first-device-identifying-module controller 292 (and other suitable components of the first device-identifying module 290) to be powered by the strap-feeding assembly 200 (such as when the strap-feeding assembly 200 is mounted to a suitable dock on the frame and itself powered by a power source of the strapping machine), and in certain embodiments is combined with the first communications interface 296. In other embodiments, the first device-identifying module 290 has its own internal power source, such as a battery. Certain embodiments of the first device-identifying module 290 include a housing enclosing some or all of the above components, depending on the embodiment. In certain embodiments, the first device-identifying module 290 is integrated into the strap-feeding assembly 200, which in other embodiments it is a separate component connected to the strap-feeding assembly 200, such as via one or more wires.

The first device-identifying-module controller 290 includes a processing device (or devices) 292a communicatively connected to a memory device (or devices) 292b. The processing device 292a may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device 292b may include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media.

The memory device 292b stores data representing a first device identifier 294. The first device identifier includes suitable indicia that is associated with the strap-feeding device 200 and that uniquely identifies the strap-feeding assembly 200 with respect to the other assemblies of the strapping head 10. In this example embodiment, the device-identifying-module controller 290 is configured to receive the first device identifier 294 during configuration of the first device-identifying module 290 (such as via a suitable input device) and to generate and store the data representing the first device identifier 294. The memory device 292b also stores instructions executable by the processing device 292a to automatically and periodically transmit the data representing the first device identifier 294 to the strapping-machine controller 1000 via the first communications interface 296 and the communications interface of the strap-feeding assembly 200 once the first-device-identifying-module controller 292 is powered via the first power interface 298. More specifically, as soon as the first-device-identifying-module controller 292 is powered on, it sends a signal representing the first device identifier 294 to the strapping-machine controller 1000 at predetermined intervals.

The strapping-machine controller 1000 is configured to process the received signal and to generate and store data representing the first device identifier 294 based on the processed signal. The strapping-machine controller 1000 is configured to associate data generated based on feedback from the sensors 280 with the first device identifier 294 and send that data (and its association with the first device identifier 294) to the computing device 3000 via the network 2000.

In this example embodiment, the first device identifier 294 is a nine-digit base-ten first serial number (though it may have more or fewer digits in other embodiments). In this example embodiment, the device-identifying-module controller 290 is configured to receive the base-ten first serial number during configuration (or reconfiguration) of the first device-identifying module 290 (such as via a suitable input device) and to generate and store data representing the base-ten first serial number. In this example embodiment, the device-identifying-module controller 290 is configured to convert the base-ten first serial number into a 32-bit binary number and store the binary first serial number as the data representing the base-ten first serial number. For example, if the device-identifying-module controller 290 receives the base-ten first serial number 123456789, the device-identifying-module controller 290 converts it into the binary first serial number 00000111010110111100110100010101 and stores that binary first serial number.

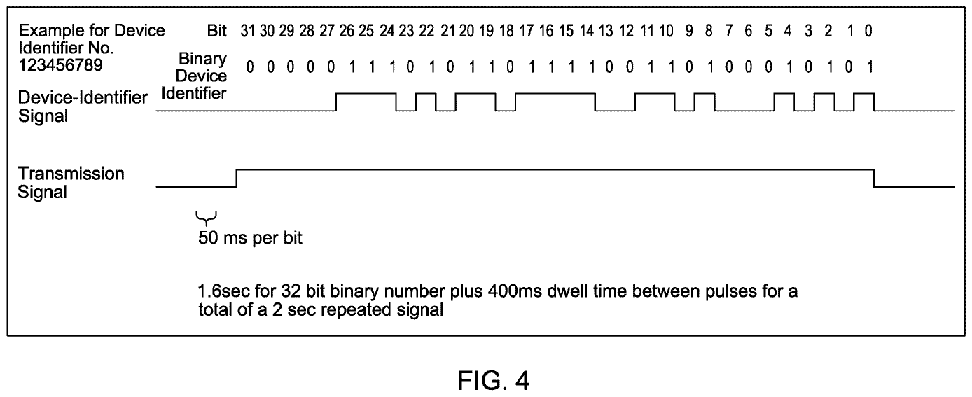

In this example embodiment, once the device-identifying-module controller 290 is powered on, the device-identifying-module controller 290 is configured to generate and simultaneously transmit two signals to the strapping-machine controller 1000 at predetermined intervals. The signals include a transmission signal and a device-identifier signal transmitted over the same first signal period. The transmission signal is configured to indicate the beginning and the end of the device-identifier signal to the strapping-machine controller 1000, and the device-identifier signal represents the binary first serial number. In this example embodiment, the transmission signal includes a continuous pulse signal transmitted over the first signal period. In this example embodiment, the first signal period is 1,600 milliseconds (though it may be any suitable length in other embodiments). In this example embodiment, the device-identifier signal includes one or more pulse signals transmitted at particular time periods during the first signal period. Specifically, the first signal period is divided into 32 different, equal second signal periods, which are 50 milliseconds each in this example embodiment. Each of the 32 second signal periods is associated with a bit of the 32-bit binary first serial number and is associated with a “0” or a “1” as appropriate. The device-identifier signal includes a pulse signal transmitted during the second signal periods (here, the 50 milliseconds) associated with a “1” of the 32-bit binary first serial number and not transmitted during the second signal periods associated with a “0” of the 32-bit binary first serial number. FIG. 4 shows an example device-identifier signal for the base-ten device identifier 123456789 and associated binary identifier 00000111010110111100110100010101.

The device-identifying-module controller 290 transmits the transmission signal and the device-identifier signal simultaneously and repeatedly, with each pair of transmissions separated by a dwell period. In this example embodiment, the dwell period is 400 milliseconds (though it may be any other suitable time period), meaning that the device-identifying-module controller 290 transmits the transmission signal and the device-identifier signal for the first signal period-1,600 milliseconds-and waits 400 milliseconds before again transmitting the transmission signal and the device-identifier signal. In this example embodiment, the device-identifying-module controller 290 is configured to transmit the signals continuously until the device-identifying-module controller 290 is powered off (though in other embodiments the device-identifying-module controller 290 is configured to transmit the signals for a particular period of time before stopping or to transmit a particular quantity of the signals before stopping).

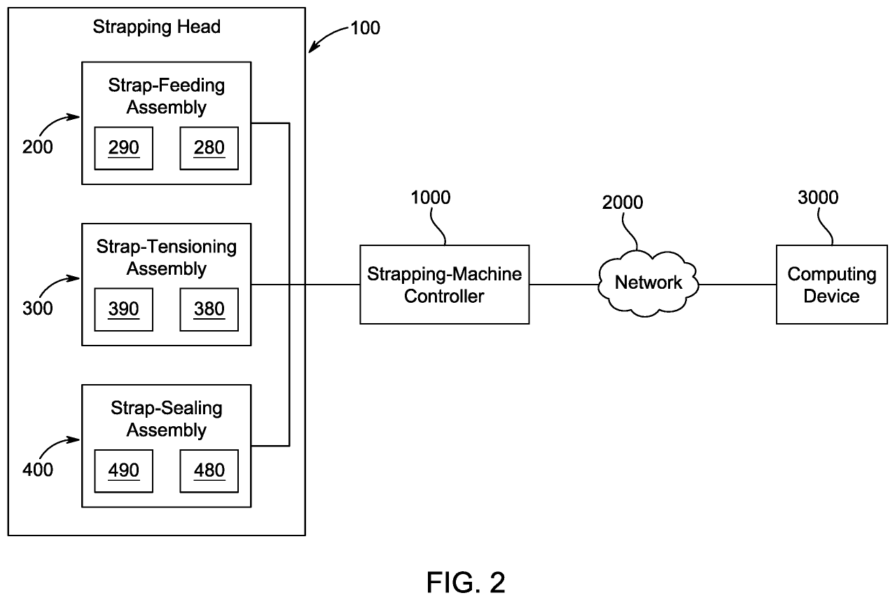

The strapping-machine controller 1000 is configured to use the transmission signal to determine the beginning and the end of the device-identifier signal. Specifically, the strapping-machine controller 1000 determines that the device-identifier signal begins when reading the start of the pulse signal of the transmission signal and that the device-identifier signal ends when the pulse signal of the transmission signal stops. The strapping-machine controller 1000 is configured to determine the binary first serial number based on the device-identifier signal. This enables the strapping-machine controller 1000 to link the installed strap-feeding assembly 200—and more particularly, its device identifier—to any data generated by sensors of that strap-feeding assembly 200. As shown in FIG. 2, the strapping-machine controller 1000 is configured to communicate with an external computing device 3000, such as a cloud-based server, via a network 2000, such as the internet, and a suitable wired or wireless communications interface. The strapping-machine controller 1000 is configured to send data to the computing device 3000 for storage and/or analysis, such as for predictive maintenance.

The second device-identifying module 390 is substantially similar to the first device-identifying module 290 and is not shown in further detail. In other words, the structure and functionality of the second device-identifying module 390 is substantially similar to that of the first device-identifying module 290. One difference is that the memory device of the second device-identifying-module processor stores data representing a second device identifier that uniquely identifies the strap-tensioning assembly 300 with respect to the other assemblies of the strapping head 10. Similarly, the third device-identifying module 490 is substantially similar to the first device-identifying module 290 and is not shown in further detail. In other words, the structure and functionality of the third device-identifying module 490 is substantially similar to that of the first device-identifying module 290. One difference is that the memory device of the third device-identifying-module processor stores data representing a third device identifier that uniquely identifies the strap-sealing assembly 400 with respect to the other assemblies of the strapping head 10.

While in the above example embodiment the device-identifying modules are configured for identifying devices in the form of the individual strap-feeding, strap-tensioning, and strap-sealing assemblies of the strapping machine, they may be configured for identifying any suitable devices of the strapping machine. For example, in other embodiments in which the strapping head is a single unit comprising the strap-feeding, strap-tensioning, and strap-sealing assemblies (rather than three separate units), the device-identifying module is configured for identifying the strapping head as a whole.

1. A strapping machine for strapping a load, the strapping machine comprising:
a frame;
a device supported by the frame and configured to carry out at least part of a strapping process to form a tensioned loop of strap around the load;
a strapping-machine controller configured to control the device to carry out the at least part of the strapping process; and
a device-identifying module for identifying the device, the device-identifying module comprising a device-identifying-module controller communicatively connected to the strapping-machine controller, wherein the device-identifying-module controller is configured to store data representing a device identifier associated with the device and is configured to, when powered on, automatically generate and transmit a device-identifier signal representing the device identifier to the strapping-machine controller.

2. The strapping machine of claim 1, further comprising a strap chute shaped and positioned to circumscribe the load, wherein the device comprises a strapping head configured to carry out the strapping process by feeding strap around the strap chute, retracting strap from the strap chute onto the load, tensioning the strap around the load, and sealing the strap to itself to form the tensioned loop of strap around the load.

3. The strapping machine of claim 1, further comprising a strap chute shaped and positioned to circumscribe the load and a strapping head configured to carry out the strapping process by feeding strap around the strap chute, retracting strap from the strap chute onto the load, tensioning the strap around the load, and sealing the strap to itself to form the tensioned loop of strap around the load, wherein the device comprises the strapping head

4. The strapping machine of claim 3, wherein the device-identifying module is electrically connected to the device such that the device is configured to power the device-identifying-module controller.

5. The strapping machine of claim 4, wherein the device comprises a housing and the device-identifying module is at least partially enclosed within the housing.

6. The strapping machine of claim 3, wherein the strapping head comprises a strap-feeding assembly configured to feed the strap around the strap chute and retract the strap from the strap chute, a strap-tensioning assembly configured to tension the strap around the load, and a strap-sealing assembly configured to seal the strap to itself, wherein the strap-feeding assembly, the strap-tensioning assembly, and the strap-sealing assembly are individually removably mounted to the frame, wherein the device comprises one of the strap-feeding assembly, the strap-tensioning assembly, and the strap-sealing assembly.

7. The strapping machine of claim 6, wherein the strapping-machine controller is configured to process the device-identifier signal and to generate and store second data representing the device identifier based on the device-identifier signal.

8. The strapping machine of claim 7, wherein the device further comprises a sensor configured to sense a physical phenomenon related to operation of the device during the at least part of the strapping process and to generate and transmit a representative output signal to the strapping-machine controller, wherein the strapping-machine controller is configured to generate output data based on the output signal and store the output data in association with the second data representing the device identifier.

9. The strapping machine of claim 1, wherein the strapping-machine controller is configured to process the device-identifier signal and to generate and store second data representing the device identifier based on the device-identifier signal.

10. The strapping machine of claim 9, wherein the device further comprises a sensor configured to sense a physical phenomenon related to operation of the device during the at least part of the strapping process and to generate and transmit a representative output signal to the strapping-machine controller, wherein the strapping-machine controller is configured to generate output data based on the output signal and store the output data in association with the second data representing the device identifier.

11. The strapping machine of claim 9, wherein the device-identifying-module controller is further configured to, when powered on, automatically generate and transmit a transmission signal to the strapping-machine controller simultaneously with the device-identifier signal.

12. The strapping machine of claim 11, wherein the transmission signal identifies a beginning and an end of the device-identifier signal.

13. The strapping machine of claim 12, wherein the device identifier comprises a base-ten number, wherein the device-identifier signal comprises one or more pulse signals representative of a binary equivalent of the base-ten number.

14. The strapping machine of claim 12, wherein the device-identifier controller is configured to simultaneously transmit the device-identifier signal and the transmission signal to the strapping-machine controller during a first signal period.

15. The strapping machine of claim 14, wherein the transmission signal comprises a continuous pulse signal.

16. The strapping machine of claim 14, wherein the device-identifier controller is configured to repeatedly simultaneously transmit the device-identifier signal and the transmission signal to the strapping-machine controller during successive first-signal periods separated by a dwell period during which the device-identifying-module controller is configured not to send the device-identifier signal or the transmission signal to the strapping-machine controller.

17. A method for identifying a device of a strapping machine using a device-identifying module of the strapping machine, the method comprising:
powering a device-identifying-module controller of the device-identifying module;
responsive to being powered, automatically transmitting, via the device-identifying-module controller, a device-identifier signal representing a device identifier to a controller; and
processing, via the controller, the device-identifier signal and generating and storing data representing the device-identifier signal.

18. The method of claim 17, further comprising:
sensing, via a sensor, a physical phenomenon related to operation of the device during at least part of a strapping process;
generating and transmitting, via the sensor, a representative output signal to the controller;
generating, via the controller, output data based on the output signal; and
storing, via the controller, the output data in association with the data representing the device identifier.

19. The method of claim 17, further comprising, responsive to being powered, automatically transmitting, via the device-identifying-module controller, a transmission signal to the controller simultaneously with the device-identifier signal.

20. The method of claim 19, wherein the transmission signal identifies a beginning and an end of the device-identifier signal.
